(19) United States
(12) Patent Application Publication
(10) Pub. No.: US 2019/0082001 A1
(43) Pub. Date: Mar. 14, 2019

(54) INFORMATION PROCESSING APPARATUS, INFORMATION PROCESSING METHOD, AND INFORMATION PROCESSING SYSTEM

(71) Applicant: Naoki CHIYO, Kanagawa (JP)

(72) Inventor: Naoki CHIYO, Kanagawa (JP)

(21) Appl. No.: 16/103,322

(22) Filed: Aug. 14, 2018

(30) Foreign Application Priority Data
Sep. 14, 2017 (JP) 2017-177183

(51) Int. Cl. H04L 29/08; G06F 21/62; G06F 21/60

(52) U.S. Cl. CPC H04L 67/06; G06F 21/602; G06F 21/6218; H04L 67/327

(57) ABSTRACT

An information processing apparatus includes processing circuitry to: obtain upload-requesting-source information indicating at least one requesting source that has requested for uploading file data; and register, in a memory, the obtained upload-requesting-source information to be used to determine download availability of the file data.

### CROSS-REFERENCE TO RELATED APPLICATIONS

This patent application is based on and claims priority pursuant to 35 U.S.C. § 119(a) to Japanese Patent Application No. 2017-177183, filed on Sep. 14, 2017, in the Japan Patent Office, the entire disclosure of which is hereby incorporated by reference herein.

### BACKGROUND

### Technical Field

The present invention relates to an information processing apparatus, an information processing method, and an information processing system.

### Description of the Related Art

In the background system for remotely managing devices, file data such as device information is uploaded to an information processing apparatus in a cloud, and the file data is downloaded by use of an application, etc., for managing devices. For example, a file ID, which is generated at a time of uploading file data, is designated for downloading the file data. For another example, a search is performed to find, from among conference-handout data associated with a user account, conference-handout data that matches with a conference-passcode.

### SUMMARY

Example embodiments of the present invention include an information processing apparatus including processing circuitry to: obtain upload-requesting-source information indicating at least one requesting source that has requested for uploading file data; and register, in a memory, the obtained upload-requesting-source information to be used to determine download availability of the file data.

Example embodiments of the present invention include an information processing system including: a requesting device; and an information processing apparatus. The requesting device includes first circuitry to transmit to the information processing apparatus an upload request including identification information of all devices that have been involved to request for uploading file data. The information processing apparatus includes second circuitry to: receive the upload request from the requesting device; obtain, based on the identification information included in the received upload request, upload-requesting-source information indicating at least one requesting source of the upload request of file data; and register, in a memory, the obtained upload-requesting-source information to be used to determine download availability of the file data.

Example embodiments of the present invention include an information processing method performed by the information processing apparatus, and a non-transitory recording medium storing a control program for performing an information processing method.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a diagram illustrating an example of a system configuration of an information processing system according to an embodiment;

FIG. 2 is a diagram illustrating an example of a hardware configuration of an information processing apparatus on a cloud according to the embodiment;

FIG. 3 is a block diagram illustrating an example of a functional configuration of the information processing apparatus on the cloud according to the embodiment;

FIG. 4 is a diagram illustrating an example of information stored in a file memory unit according to the embodiment;

FIG. 5A is a diagram illustrating an example of information stored in a connection information memory unit according to the embodiment;

FIG. 5B is a diagram illustrating an example of information stored in the connection information memory unit according to the embodiment;

FIG. 5C is a diagram illustrating an example of information stored in the connection information memory unit according to the embodiment;

FIG. 6A is a block diagram illustrating an example of a functional configuration of an application according to the embodiment;

FIG. 6B is a block diagram illustrating an example of a functional configuration of a mediation apparatus according to the embodiment;

FIG. 6C is a block diagram illustrating an example of a functional configuration of a device according to the embodiment;

FIG. 7 is a diagram illustrating an example of a connection state in the information processing system according to the embodiment;

FIG. 8 is a diagram illustrating an example of a specification in the connection state illustrated in FIG. 7 regarding access to file data;

FIG. 9 is a diagram for explaining an example of upload types according to the embodiment;

FIG. 10 is a sequence diagram illustrating an example of the flow of a process of uploading from an application according to the embodiment;

FIG. 11 is a diagram illustrating an example of a certificate of an application according to the embodiment;

FIG. 12 is a sequence diagram illustrating an example of the flow of a process of uploading from a mediation apparatus according to the embodiment;

FIG. 13 is a diagram illustrating an example of an HTTP header transmitted at a time of an upload from a mediation apparatus according to the embodiment;

FIG. 14 is a sequence diagram illustrating an example of the flow of an upload process performed by a device according to the embodiment via a mediation apparatus;

FIG. 15 is a diagram illustrating an example of an HTTP header transmitted at a time of an upload from a device according to the embodiment;

FIG. 16 is a sequence diagram illustrating an example of the flow of an upload process performed by a mediation apparatus in response to a request from an application according to the embodiment;

FIG. 17 is a diagram illustrating an example of command information according to the embodiment;

FIG. 18 is a sequence diagram illustrating an example of the flow of a download process in a case where an application according to the embodiment is a download-requesting device;

FIG. 19 is a sequence diagram illustrating an example of the flow of a download process in a case where a mediation apparatus according to the embodiment is a download-requesting device;

FIG. 20 is a flowchart illustrating an example of the flow of a determining process at a time of an upload according to the embodiment; and

FIG. 21 is a flowchart illustrating an example of the flow of a determining process at a time of a download according to the embodiment.

The accompanying drawings are intended to depict embodiments of the present invention and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

The following description explains an information processing apparatus, an information processing method, an information processing system, and a recording medium according to one or more embodiments of the present invention, with reference to the attached drawings. Note that the present invention is not limited to the following embodiments.

### Embodiment

<System Configuration>

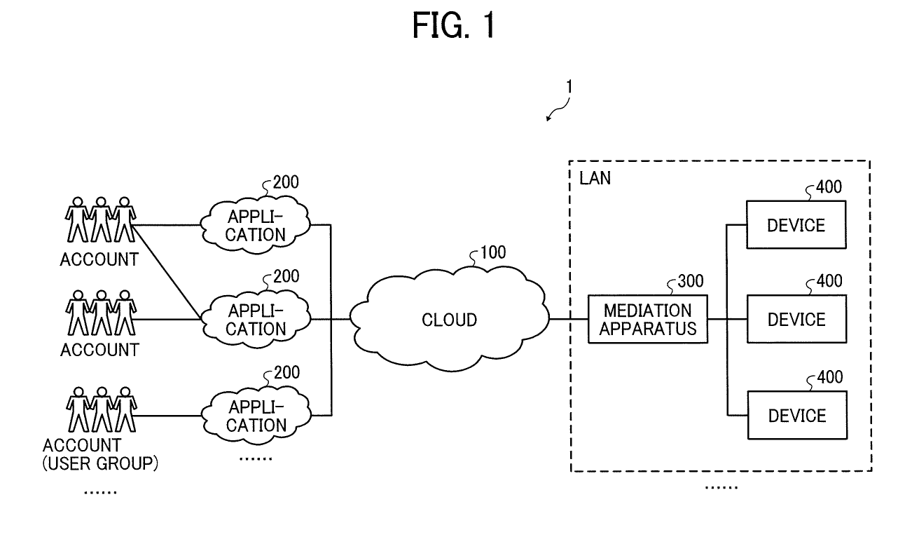

With reference to FIG. 1, a system configuration of an information processing system 1 according to an embodiment is described. FIG. 1 is a diagram illustrating an example of a system configuration of the information processing system 1 according to the embodiment.

As illustrated in FIG. 1, the information processing system 1 includes an information processing apparatus that resides on a cloud 100 (for the descriptive purposes, it is referred to as the “cloud 100”), an application 200, a mediation apparatus 300, and a device 400. An account corresponds to grouped users. Note that the information processing system 1 may include multiple applications 200, mediation apparatuses 300, and devices 400. Furthermore, each of the application 200, the mediation apparatus 300, and the device 400 corresponds to a “requesting device”.

The application 200 utilizes a function provided by the cloud 100 for accessing a device, so as to provide a particular service. For example, the application 200 provides a service such as a log-collecting service, a counter-collecting service, or a device-maintenance service. The cloud 100 retains information indicative of a connection state, a communication path, etc., for transmitting and receiving information among the application 200, the mediation apparatus 300, and the device 400, so as to control two-way communication between the application 200 and the device 400.

The mediation apparatus 300 is installed inside a local area network (LAN) protected by a firewall, so as to access the device 400 or notify the cloud 100 of an alert from the device 400 in accordance with an instruction from the cloud 100. For example, the mediation apparatus 300 obtains device information or performs alive monitoring, etc., regarding the device 400, based on preset schedule information. The device 400 is an apparatus to be monitored (monitored apparatus), i.e., an apparatus that is a target of maintenance, counter meter reading, etc. For example, the device 400 may be a copier, a projector, a household appliance, a vending machine, a medical equipment, a 3-D printer, a power-supply equipment, an air-conditioning system, a measuring system for gas and water services, a sensor (e.g., an image-capturing apparatus, a sound-collecting apparatus, a human sensor, etc.), etc., which is provided with a network communication capability.

For example, the medical equipment may be a funduscopy device, an X-ray examination device, a sphygmomanometer, a body fat analyzer, a vision analyzer, a pace maker, etc. The medical equipment outputs identification information, operation status, and occurrence of irregular operation of the medical equipment itself and results of measurement, etc., using various types of information communicating functions exemplified by a data format or an image format, etc. Furthermore, as a modeling method of a 3-D printer, there may be a material extrusion deposition (i.e., fused deposition modeling or FDM), material jetting, binder jetting, selective laser sintering (SLS), stereolithography (SLA), etc. The 3-D printer outputs identification information, operation status, occurrence of irregular operation, conditions of installed consumables of the 3-D printer itself, etc., using various types of information communicating functions. The sensor may be attached to any kind of industrial machines or to a periphery of an industrial machine, such that the sensor is able to obtain information regarding an industrial machine. For example, the industrial machine may be a processing machine, a carrier machine, an examination machine, etc.

Having the configuration described above, the cloud 100 accepts an upload request from the application 200, the mediation apparatus 300, or the device 400 for uploading file data. In addition to file data, an upload request may include a file ID, upload-requesting-source information indicative of a requesting source of requesting for an upload of file data. That is to say, at a time of an upload, the application 200, the mediation apparatus 300, or the device 400, etc., transmits to the cloud 100 an upload request including identification information for identifying the self.

Furthermore, the cloud 100 obtains upload-requesting-source information included in an upload request and registers obtained file data, file ID, upload-requesting-source information, etc., in a file memory unit, which is used at a time of determining download availability of file data.

That is to say, in addition to file data and a file ID, the file memory unit stores information of a device that has actually requested for an upload. Therefore, it is possible to confirm access authority over file data by confirming upload-requesting-source information at a time of a download request of a file. Accordingly, the cloud 100 improves security regarding obtainment of file data.

<Hardware Configuration>

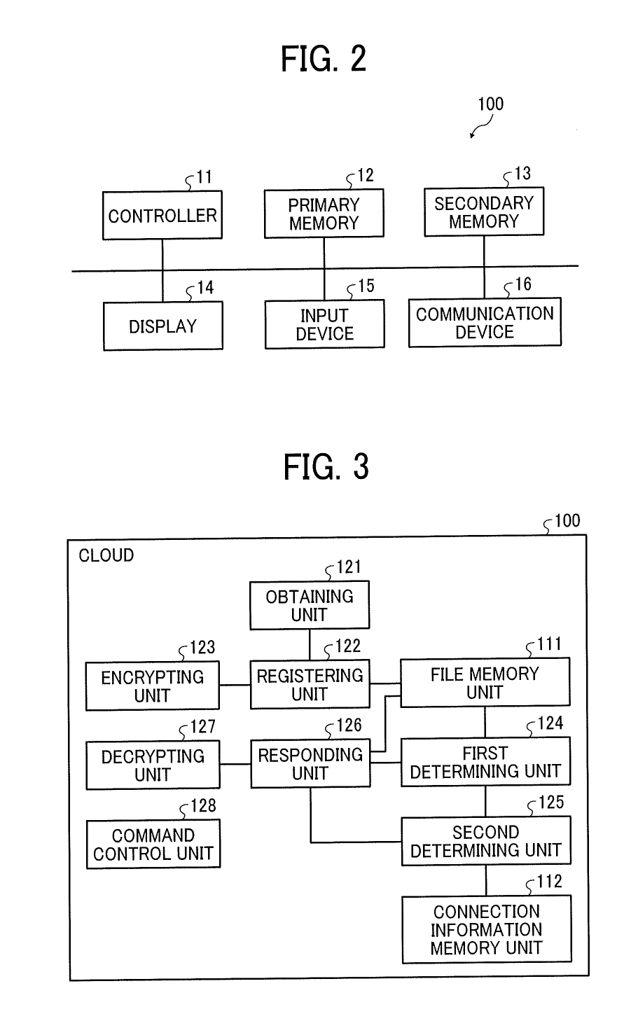

Next, with reference to FIG. 2, a hardware configuration of the cloud 100 according to the embodiment is explained. FIG. 2 is a diagram illustrating an example of a hardware configuration of the cloud 100 (the information processing apparatus) according to the embodiment.

As illustrated in FIG. 2, the cloud 100 includes a controller 11, a primary memory 12 (i.e., memory), a secondary memory 13 (i.e., memory), a display 14, an input device 15, and a communication device 16. The above-described units are interconnected via a bus. The controller 11 is a central processing unit (CPU) or a graphics processing unit (GPU), etc., which utilizes the primary memory 12 as a work area to execute a program stored in the primary memory 12, the secondary memory 13, etc., so as to generally control operation of the cloud 100. Hence, the cloud 100 achieves various types of functions described below.

The primary memory 12 is a read only memory (ROM) or a random access memory (RAM), etc. The secondary memory 13 is a hard disk drive (HDD) or a solid state drive (SSD), etc. The display 14 is a display, etc., such as a liquid crystal display. The input device 15 is a keyboard or a mouse, etc. The communication device 16 is a communication interface, which controls communication between the application 200 and the mediation apparatus 300 (or the device 400).

<Functional Configuration>

Next, with reference to FIG. 3, a functional configuration of the cloud (information processing apparatus) 100 according to the embodiment is explained. FIG. 3 is a block diagram illustrating an example of a functional configuration of the cloud 100 according to the embodiment.

As illustrated in FIG. 3, the cloud 100 includes a file memory unit 111 (i.e., primary memory or secondary memory) and a connection information memory unit 112 (i.e., primary memory or secondary memory). Furthermore, the cloud 100 includes an obtaining unit 121, a registering unit 122, and an encrypting unit 123. Furthermore, the cloud 100 includes a first determining unit 124, a second determining unit 125, a responding unit 126, and a decrypting unit 127. Furthermore, the cloud 100 includes a command control unit 128.

The file memory unit 111 stores file data and various types of information relating to file data. File data to be stored in the file memory unit 111 is registered in response to an upload request. Furthermore, the file memory unit 111 is used at a time of determining download availability of file data.

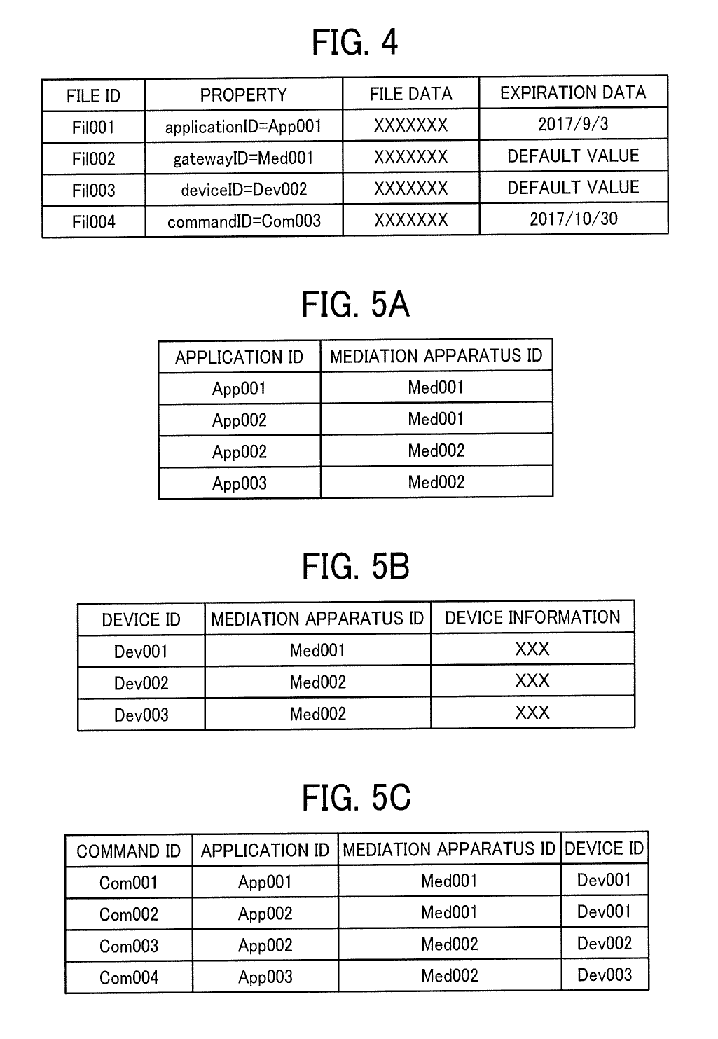

FIG. 4 is a diagram illustrating an example of information stored in the file memory unit 111 according to the embodiment. As illustrated in FIG. 4, the file memory unit 111 stores such information as a file ID, property, file data, and an expiration date. A file ID is information for identifying file data. Property is information (i.e., upload-requesting-source information) indicative of a requesting source of an upload request of file data. File data is uploaded file data. An expiration data is information (i.e., expiration data information) indicative of an expiration data of downloading file data.

For example, the file memory unit 111 stores file ID “Fil001”, property “applicationID=App001”, file data “XXXXXXX”, and an expiration date “2017/9/3” in an associated manner. As described above, property includes upload-requesting-source information. For example, “applicationID” is information indicating that the upload requesting source is an application 200, and “App001” is information for identifying the application 200. Furthermore, “gatewayID” is information indicating that the upload requesting source is the mediation apparatus 300, and “Med001” is information for identifying the mediation apparatus 300. Furthermore, “deviceID” is information indicating that the upload requesting source is the device 400, and “Dev002” is information for identifying the device 400. Furthermore, “commandID” is information indicative of a request output by an application 200, which is the upload requesting source, and “Com003” is information for identifying a command.

The connection information memory unit 112 stores connection information indicative of a connection state used for transmitting and receiving information between requesting sources of an upload request. The connection information stored in the connection information memory unit 112 is information registered at a time of building the information processing system 1 and is stored in advance prior to actual operation.

Each of FIGS. 5A through 5C is a diagram illustrating an example of information stored in the connection information memory unit 112 according to the embodiment. As illustrated in FIG. 5A, in an application-and-mediation apparatus table, an application ID and a mediation apparatus ID are stored in an associated manner. An application ID is information for identifying an application 200. A mediation apparatus ID is information for identifying a mediation apparatus 300. Identification information associated in the application-and-mediation apparatus table indicate that a corresponding pair of the application 200 and the mediation apparatus 300 are capable of transmitting and receiving information therebetween.

As illustrated in FIG. 5B, in a device information table, such information as a device ID, a mediation apparatus ID, and device information are stored in an associated manner. A device ID is information for identifying the device 400. Device information is information relating to the device 400. Identification information associated in the device information table indicate that a corresponding pair of the mediation apparatus 300 and the device 400 are capable of transmitting and receiving information therebetween.

As illustrated in FIG. 5C, in a command table, such information as a command ID, an application ID, a mediation apparatus ID, and a device ID are stored in an associated manner. A command ID is information for identifying a command generated in response to a request output by an application 200. Identification information associated in the command table indicates that a corresponding group of the application 200, the mediation apparatus 300 and the device 400 are capable of transmitting and receiving information therebetween.

The obtaining unit 121 obtains upload-requesting-source information. More specifically, when an upload request for uploading file data is accepted, the obtaining unit 121 obtains file data, a file ID, and upload-requesting-source information, which are included in the upload request. The upload request for uploading file data is received by the communication device 16. Furthermore, in a case where expiration data information is included in the upload request, the obtaining unit 121 obtains the expiration data information as well.

The registering unit 122 registers upload-requesting-source information in the file memory unit 111. More specifically, the registering unit 122 registers file data, a file ID, upload-requesting-source information, which are obtained by the obtaining unit 121, in the file memory unit 111 in an associated manner. Furthermore, in a case where expiration date information is obtained by the obtaining unit 121, the registering unit 122 further registers the expiration date information in the file memory unit 111 in an associated manner. Contrarily, in a case where expiration date information is not obtained by the obtaining unit 121, the registering unit 122 registers predetermined expiration date information in the file memory unit 111. For example, in a case where there is not designated expiration date information, the registering unit 122 registers a date after a predetermined number of days from the current date as expiration date information in the file memory unit 111. Furthermore, the registering unit 122 may request the encrypting unit 123 to encrypt file data, so as to register the encrypted file data in the file memory unit 111.

The encrypting unit 123 encrypts file data. More specifically, the encrypting unit 123 encrypts, in response to a request from the registering unit 122, file data that is a registration-processing target and responds to the registering unit 122 with the encrypted file data. Having the above functional configuration, an upload process of file data is completed. In the following, a download process of file data is explained.

In response to a download request of file data, the first determining unit 124 determines download availability of the file data. More specifically, the first determining unit 124 determines whether download-requesting-device information, which is indicative of a device that has requested for downloading file data, matches with property information (i.e., upload-requesting-source information) stored in the file memory unit 111. A download request of file data is received by the communication device 16. A download request includes a file ID of file data, which is a download target, and download-requesting-device information.

Particularly, the first determining unit 124 refers to the file memory unit 111 and obtains property information corresponding to a file ID included in a download request. Then, the first determining unit 124 determines whether download-requesting-device information included in the download request matches with the obtained property information. In a case where the download-requesting-device information matches with the property information, the first determining unit 124 determines that file data can be downloaded because the download-requesting person is the same as the upload-requesting source. Contrarily, in a case where the download-requesting-device information does not match with the property information, the first determining unit 124 determines that file data cannot be downloaded because the download-requesting person is not the same as the upload-requesting source and therefore the download-requesting person does not have access authority over the file data. Note that an access error occurs in a case where a corresponding file ID does not exist in the file memory unit 111.

In a case where the first determining unit 124 determines that downloading is not possible, the second determining unit 125 further determines download availability of file data. More specifically, in a case where the first determining unit 124 determines that downloading is not possible, the second determining unit 125 refers to connection information stored in the connection information memory unit 112, so as to determine whether property information (i.e., upload-requesting-source information) is included in the connection information corresponding to download-requesting-device information.

Determination as to which of the tables illustrated in FIGS. 5A through 5C is utilized is made, based on property information. That is to say, in a case where property information is “applicationID”, the application-and-mediation apparatus table (c.f., FIG. 5A) may be referred to. Further, in a case where property information is “gatewayID”, the application-and-mediation apparatus table (c.f., FIG. 5A) may be referred to. Further, in a case where property information is “deviceID”, the device information table (c.f., FIG. 5B) may be referred to. Further, in a case where property information is “commandID”, the command table (c.f., FIG. 5C) may be referred to.

In a case where file data is downloaded from the cloud 100, the device that has requested the cloud 100 for a download is not necessarily the requesting source. Therefore, the second determining unit 125 confirms connection information regarding the device that has requested for a download, so as to confirm access authority over file data. As a result, in a case where property information is included in the connection information corresponding to download-requesting-device information, the second determining unit 125 determines that downloading of file data is possible because the download-requesting person has a connection state with the upload-requesting source and therefore the download request has been triggered by the upload-requesting source. Contrarily, in a case where property information is not included in the connection information corresponding to download-requesting-device information, the second determining unit 125 determines that downloading of file data is not possible because the download-requesting person does not have a connection state with the upload-requesting source and therefore the download request has not been triggered by the upload-requesting source.

The responding unit 126 responds to a download-requesting device with file data. More specifically, in a case where the first determining unit 124 determines that download-requesting-device information matches with property information, the responding unit 126 responds to the download-requesting device with file data. Furthermore, in a case where the second determining unit 125 determines that property information is included in connection information corresponding to download-requesting-device information, the responding unit 126 responds to the download-requesting device with file data.

Furthermore, in a case where expiration date information is registered in the file memory unit 111 and downloading is possible according to the expiration date information, the responding unit 126 responds to the download-requesting device with file data. Contrarily, in a case where downloading is not possible according to the expiration date information, the responding unit 126 responds with an access error. Furthermore, in a case where file data is encrypted, the responding unit 126 requests the decrypting unit 127 for decrypting the file data and responds to the download-requesting device with the decrypted file data. Response with file data is transmitted by the communication device 16.

The decrypting unit 127 decrypts file data. More specifically, in response to a request from the responding unit 126, the decrypting unit 127 decrypts file data and responds to the responding unit 126 with the decrypted file data.

The command control unit 128 generates a command, based on a request output by an application 200, or stores information relating to a command, etc. The information relating to a command may be a command ID, an application ID, a mediation apparatus ID, a device ID, or information indicative of a requested content of the command, etc.

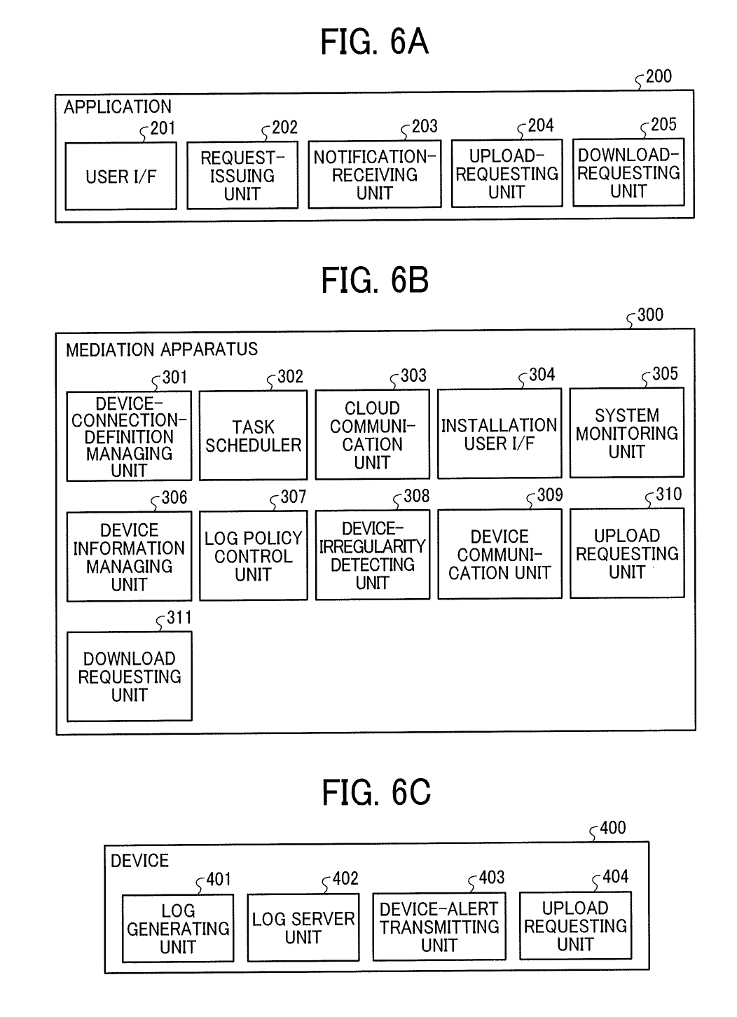

Next, with reference to FIG. 6A, a functional configuration of an application 200 according to the embodiment is explained. FIG. 6A is a block diagram illustrating an example of a functional configuration of an application 200 according to the embodiment.

As illustrated in FIG. 6A, an application 200 includes a user interface (I/F) 201, a request-issuing unit 202, a notification-receiving unit 203, an upload-requesting unit 204, and a download-requesting unit 205.

The user I/F 201 controls screen display of a screen provided with a button, etc., for confirming status, information, etc., of the device 400, the mediation apparatus 300, etc., which is a monitoring target, on a list or in detail. In accordance with an operation provided on the screen controlled by the user I/F 201, an instruction for obtaining information or for control, etc., directed to the device 400 is implemented.

The request-issuing unit 202 transmits to the cloud 100 an instruction, which is accepted through the screen displayed in accordance with control by the user I/F 201 and is directed to the mediation apparatus 300 or the device 400. It is assumed that the communication method is, for example, Hypertext Transfer Protocol Secure (HTTPS) but is not limited to HTTPS as long as the communication method enables communication.

The notification-receiving unit 203 receives a result corresponding to an instruction issued by the application 200, a voluntary alert notification from the mediation apparatus 300 or the device 400, etc.

The upload-requesting unit 204 requests the cloud 100 for uploading file data. Furthermore, at a time of an upload request, the upload request performed by the upload-requesting unit 204 includes an application ID for identifying an application 200. The download-requesting unit 205 requests the cloud 100 for downloading file data. Furthermore, at a time of a download request, the download request performed by the download-requesting unit 205 includes a file ID of file data, which is a download target.

Next, with reference to FIG. 6B, a functional configuration of the mediation apparatus 300 according to the embodiment is explained. FIG. 6B is a block diagram illustrating an example of a functional configuration of the mediation apparatus 300 according to the embodiment.

As illustrated in FIG. 6B, the mediation apparatus 300 includes a device-connection-definition managing unit 301, a task scheduler 302, a cloud communication unit 303, an installation user I/F 304, and a system monitoring unit 305. Furthermore, the mediation apparatus 300 includes a device information managing unit 306, a log policy control unit 307, a device-irregularity detecting unit 308, a device communication unit 309, an upload requesting unit 310, and a download requesting unit 311.

The device-connection-definition managing unit 301 utilizes a database, etc., to manage a communication parameter for adding, deleting, or searching the device 400 or for obtaining device information or conducting communication confirmation regarding the device 400. For example, in a case of HTTP, there exists a parameter of a resource Uniform Resource Identifier (URI), a method, a header, a query, or a body. Furthermore, in a case of Simple Network Management Protocol (SNMP), there exists a command type (e.g., Get/GetBulk), a version, a community name, or an object identifier (OID).

The task scheduler 302 operates in a regular manner, based on schedule information preset by a built-in clock of the mediation apparatus 300. For example, the task scheduler 302 obtains information from the device 400, which is a monitoring target, so as to provide a notification to the cloud 100 or to perform alive monitoring for confirming whether the device 400 is capable of performing network communication. Furthermore, the task scheduler 302 transmits a log in a regular manner.

The cloud communication unit 303 performs communication control. For example, the cloud communication unit 303 receives a command from the cloud 100. Furthermore, the cloud communication unit 303 transmits an alert from the device 400 to the cloud 100. It is assumed that the communication function is HTTPS but is not limited to HTTPS as long as the communication function enables communication.

The installation user I/F 304 provides a screen for performing a network setting to enable communication with the device 400 or the cloud 100 through a LAN, for performing an activation procedure to start communication with the cloud 100, for confirming a connection, etc.

The system monitoring unit 305 detects an irregular state of a system, such as a lack of memory, a lack of disk, or a write error to a disk, etc.

The device information managing unit 306 utilizes a database, etc., to manage a device identifier, a device type, a device IP address, etc., for communication with the device 400.

The log policy control unit 307 presets a policy such as whether a designated keyword exists in a string included in a log or whether a value extracted by use of a regular expression fits within a range, etc.

The device-irregularity detecting unit 308 detects an indication of irregularity, based on a policy set by the log policy control unit 307. In a case where an indication of irregularity is detected, a notification is transmitted to the cloud 100.

The device communication unit 309 transmits an instruction from the application 200 to the device 400. Furthermore, the device communication unit 309 receives a text message or a file (binary) from the device 400. It is assumed that the communication protocol is, but is not limited to, HTTPS, SNMP, etc.

The upload requesting unit 310 requests the cloud 100 for uploading file data. Furthermore, at a time of an upload request, the upload request performed by the upload requesting unit 310 includes identification information (e.g., a device ID, the own mediation apparatus ID, etc.) of all devices that have been involved for the upload request. The download requesting unit 311 requests the cloud 100 for downloading file data. Furthermore, at a time of a download request, the download request performed by the download requesting unit 311 includes a file ID of file data, which is a download target.

Next, with reference to FIG. 6C, a functional configuration of the device 400 according to the embodiment is explained. FIG. 6C is a block diagram illustrating an example of a functional configuration of the device 400 according to the embodiment.

As illustrated in FIG. 6C, the device 400 includes a log generating unit 401, a log server unit 402, a device-alert transmitting unit 403, and an upload requesting unit 404.

The log generating unit 401 records and accumulates an action log of the device 400.

The log server unit 402 responds with an action log (i.e., device information) of the device 400 in a case where a log-obtaining request from the mediation apparatus 300 is accepted.

Responding to detection of a device alert, the device-alert transmitting unit 403 transmits the device alert to the mediation apparatus 300.

The upload requesting unit 404 requests the cloud 100, via the mediation apparatus 300, for uploading file data. For example, a notification of device information may be provided to the mediation apparatus 300, so that an upload request from the device 400 is practically executed by the mediation apparatus 300.

<Connection State>

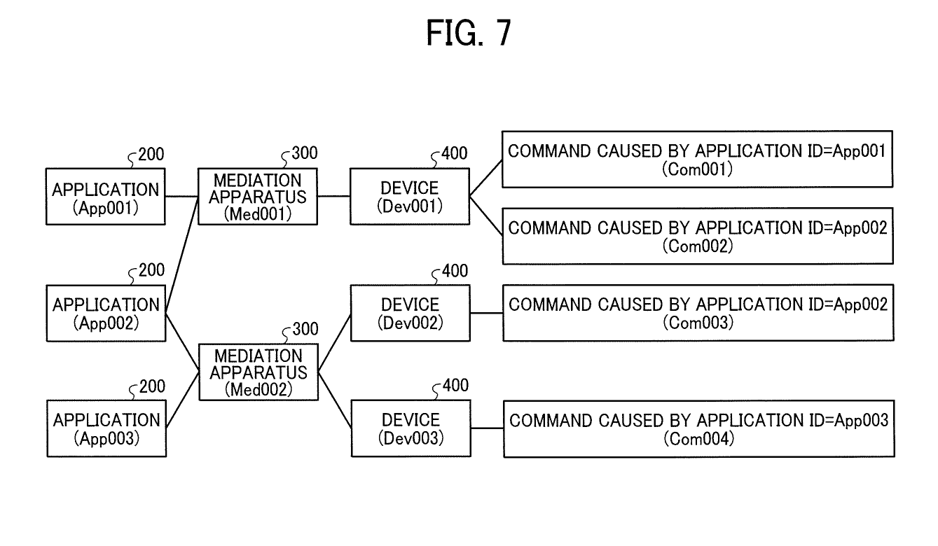

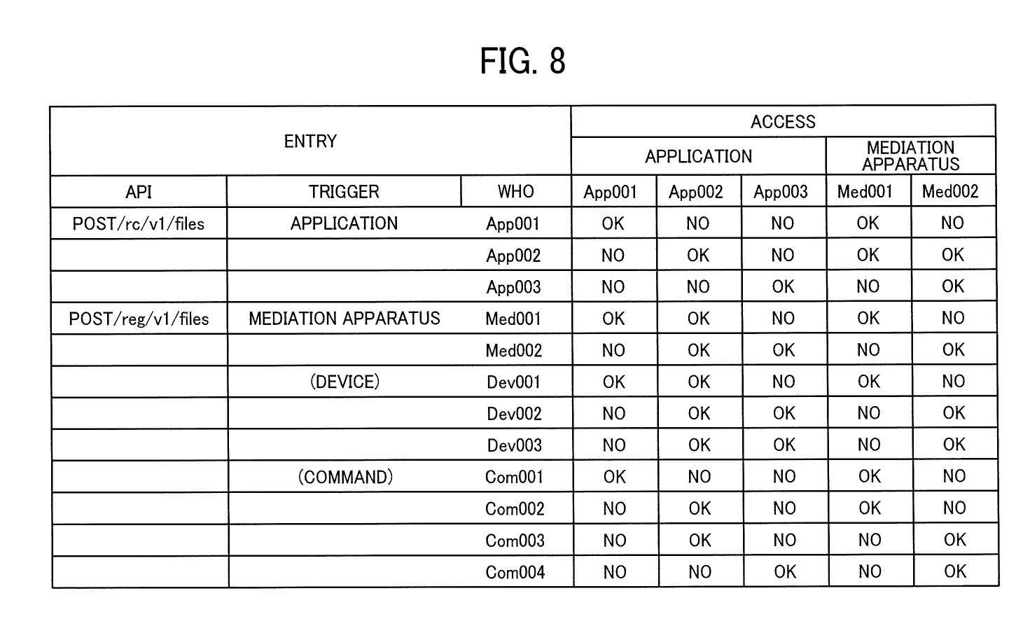

Next, with reference to FIGS. 7 and 8, a connection state of the information processing system 1 according to the embodiment is explained. FIG. 7 is a diagram illustrating an example of a connection state in the information processing system 1 according to the embodiment. FIG. 8 is a diagram illustrating an example of a specification in the connection state illustrated in FIG. 7 regarding access to file data.

As illustrated in FIG. 7, a case in which three applications 200, two mediation apparatuses 300, and three devices 400 are included in the information processing system 1 is taken as an example. Furthermore, a case in which four commands are generated in response to requests from the applications 200 is taken as an example. It is assumed that the application IDs of the applications 200 are “App001”, “App002”, and “App003”, respectively. Furthermore, it is assumed that the mediation apparatus IDs of the mediation apparatuses 300 are “Med001” and “Med002”, respectively. Furthermore, it is assumed that the device IDs of the devices 400 are “Dev001”, “Dev002”, and “Dev003”,respectively. Furthermore, it is assumed that the command IDs of the commands are “Com001”, “Com002”, “Com003”, and “Com004”, respectively.

The application 200 having the application ID “App001” is able to transmit and receive information to and from the mediation apparatus 300 having the mediation apparatus ID “Med001”. The application 200 having the application ID “App002” is able to transmit and receive information to and from the mediation apparatus 300 having the mediation apparatus ID “Med001” and the mediation apparatus 300 having the mediation apparatus ID “Med002”. The application 200 having the application ID “App003” is able to transmit and receive information to and from the mediation apparatus 300 having the mediation apparatus ID “Med002”.

The mediation apparatus 300 having the mediation apparatus ID “Med001” is able to transmit and receive information to and from the application 200 having the application ID “App001”, the application 200 having the application ID “App002”, and the device 400 having the device ID “Dev001”. The mediation apparatus 300 having the mediation apparatus ID “Med002” is able to transmit and receive information to and from the application 200 having the application ID “App002”, the application 200 having the application ID “App003”, the device 400 having the device ID “Dev002”, and the device 400 having the device ID “Dev003”.

The device 400 having the device ID “Dev001” is able to transmit and receive information to and from the mediation apparatus 300 having the mediation apparatus ID “Med001”. The device 400 having the device ID “Dev002” is able to transmit and receive information to and from the mediation apparatus 300 having the mediation apparatus ID “Med002”. The device 400 having the device ID “Dev003” is able to transmit and receive information to and from the mediation apparatus 300 having the mediation apparatus ID “Med002”.

The device 400 having the device ID “Dev001” is a target device of an instruction based on a command (i.e., command ID “Com001”), which is generated in response to a request from the application 200 having the application ID “App001”. Furthermore, the device 400 having the device ID “Dev001” is a target device of an instruction based on a command (i.e., command ID “Com002”), which is generated in response to a request from the application 200 having the application ID “App002”.

The device 400 having the device ID “Dev002” is a target device of an instruction based on a command (i.e., command ID “Com003”), which is generated in response to a request from the application 200 having the application ID “App002”. Furthermore, the device 400 having the device ID “Dev003” is a target device of an instruction based on a command (i.e., command ID “Com004”), which is generated in response to a request from the application 200 having the application ID “App003”.

In the connection state illustrated in FIG. 7, in a case where an upload request is provided by each device, access authority (i.e., download availability) over uploaded file data is as illustrated in FIG. 8. For example, as illustrated in FIG. 8, in a case where a download request is provided by the application 200 having the application ID “App001” (i.e., in a case where the application 200 having the application ID “App001” is a download-requesting device), the application 200 (itself) having the application ID “App001” and the mediation apparatus 300 having the mediation apparatus ID “Med001” have access authority over file data because, as illustrated in the connection state illustrated in FIG. 7, the application 200 having the application ID “App001” and the mediation apparatus 300 having the mediation apparatus ID “Med001” are in such a connection state that transmission and reception of information are possible. The configuration described herein is achieved by determining download availability, based on the application-and-mediation apparatus table illustrated in FIG. 5A.

Furthermore, for example, as illustrated in FIG. 8, in a case where a download request is provided by the mediation apparatus 300 having the mediation apparatus ID “Med001” (i.e., in a case where the mediation apparatus 300 having the mediation apparatus ID “Med001” is a download-requesting device), the application 200 having the application ID “App001”, the application 200 having the application ID “App002”, and the mediation apparatus 300 (itself) having the mediation apparatus ID “Med001” have access authority over file data because, as illustrated in the connection state illustrated in FIG. 7, the mediation apparatus 300 having the mediation apparatus ID “Med001” and the application 200 having the application ID “App001” are in such a connection state that transmission and reception of information are possible as well as because the mediation apparatus 300 having the mediation apparatus ID “Med001” and the application 200 having the application ID “App002” are in such a connection state that transmission and reception of information are possible. The configuration described herein is achieved by determining download availability, based on the application-and-mediation apparatus table illustrated in FIG. 5A.

In the same way as the above, configurations regarding the device 400 and a command are achieved by determining download availability, based on the device information table illustrated in FIG. 5B and the command table illustrated in FIG. 5C.

<Upload Process>

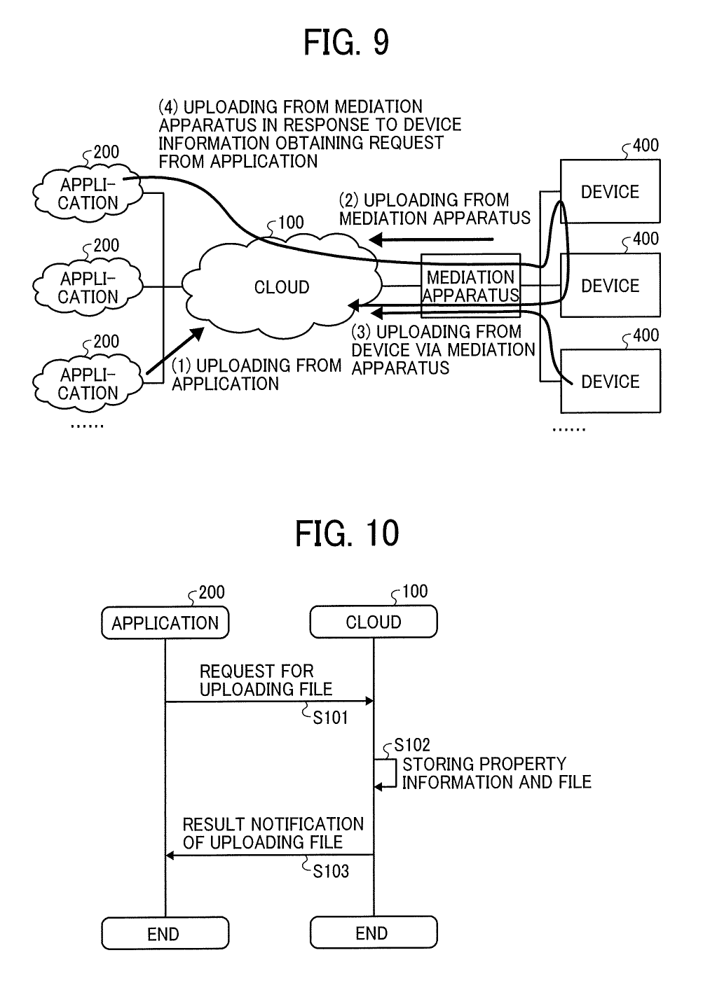

Next, with reference to FIGS. 9 through 17, an upload process according to the embodiment is explained.

FIG. 9 is a diagram for explaining an example of upload types according to the embodiment. As illustrated in FIG. 9, there exist four types (1) through (4) with respect to uploading file data:

(1) uploading from the application 200;

(2) uploading from the mediation apparatus 300;

(3) uploading from the device 400 via the mediation apparatus 300; and

(4) uploading from the mediation apparatus 300 in response to a request from the application 200.

The following description explains the flow of each upload process.

FIG. 10 is a sequence diagram illustrating an example of the flow of a process of uploading from the application 200 according to the embodiment. As illustrated in FIG. 10, the application 200 transmits to the cloud 100 an upload request for uploading file data (Step S101). The upload request for uploading file data includes file data, a file ID of the file data, an application ID of the application 200. Furthermore, the upload request may include expiration date information, etc. The expiration date information may be designated by a user of the application 200.

In response to the upload request from the application 200, the cloud 100 registers the file data, the file ID, the application ID, which is an upload-requesting-source information, etc., in the file memory unit 111 (Step S102). Furthermore, when the upload request includes expiration data information, the cloud 100 registers the expiration date information as well. Furthermore, the cloud 100 transmits to the application 200 a result notification that is indicative of completion of uploading the file data (Step S103).

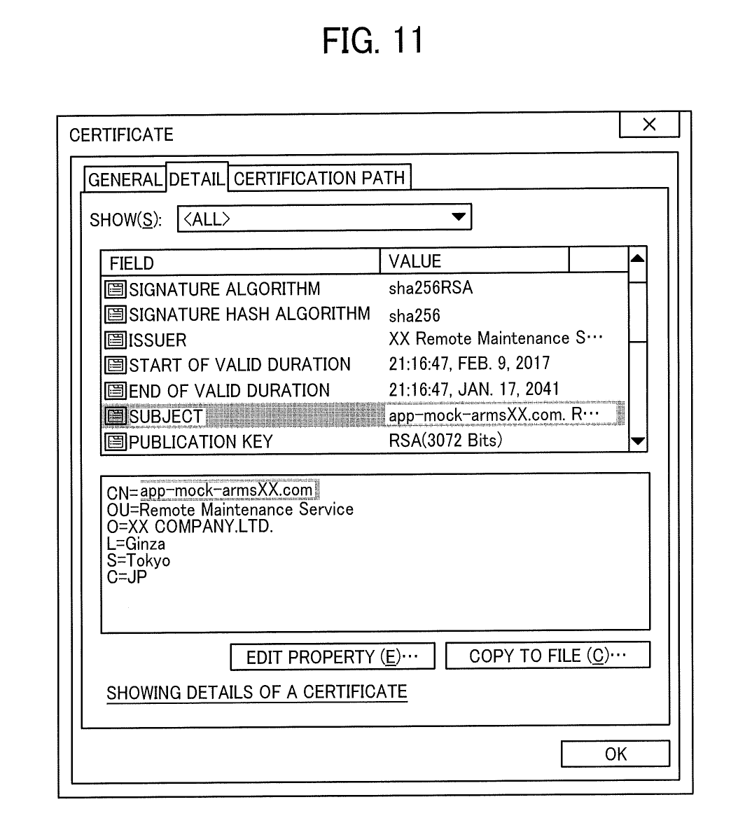

Here, the cloud 100 may, for example, confirm information regarding a certificate utilized when the application 200 communicates with the cloud 100, so as to determine which application 200 the upload request is from. FIG. 11 is a diagram illustrating an example of a certificate of the application 200 according to the embodiment. As illustrated in FIG. 11, the cloud 100 confirms CN information included in a certificate and determines which application 200 the upload request is from. It is possible to configure the cloud 100 such that the cloud 100 rejects an upload when the CN information is uncertain.

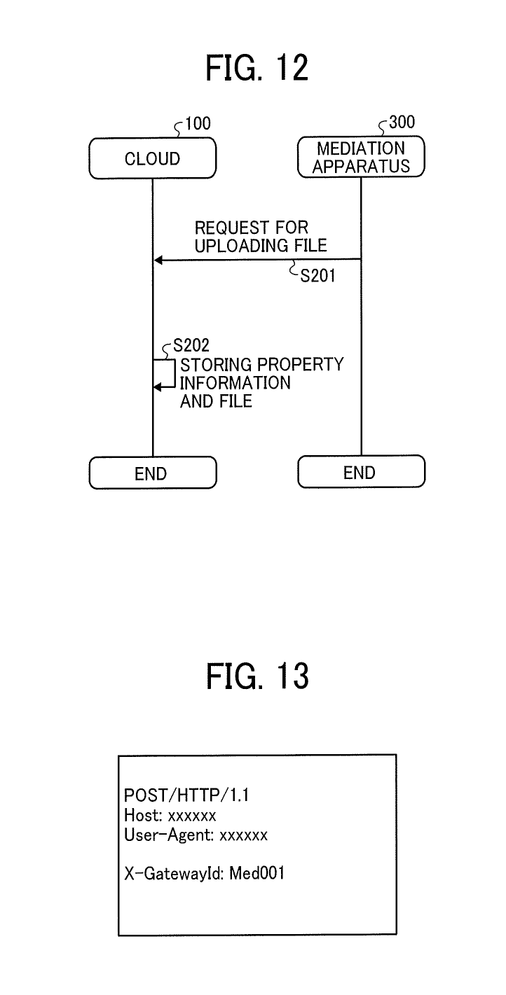

FIG. 12 is a sequence diagram illustrating an example of the flow of a process of uploading from the mediation apparatus 300 according to the embodiment. As illustrated in FIG. 12, the mediation apparatus 300 transmits to the cloud 100 an upload request for uploading file data (Step S201). The upload request for uploading file data includes the file data, a file ID of the file data, and a mediation apparatus ID of the mediation apparatus 300.

In response to the upload request from the mediation apparatus 300, the cloud 100 registers the file data, the file ID, the mediation apparatus ID, which is an upload-requesting-source information, etc., in the file memory unit 111 (Step S202). Furthermore, when the upload request does not include expiration data information and expiration date information is supposed to be set, the cloud 100 registers, as expiration date information, a date after a predetermined number of days.

Here, the mediation apparatus 300 adds the mediation apparatus ID of the mediation apparatus 300 itself to an HTTP header, etc., when the upload request of the file data is provided. FIG. 13 is a diagram illustrating an example of an HTTP header transmitted at a time of an upload from the mediation apparatus 300 according to the embodiment. As illustrated in FIG. 13, the mediation apparatus 300 adds the mediation apparatus ID of the mediation apparatus 300 itself to an HTTP header and provide an upload request of the file data. Hence, it is possible that the cloud 100 obtains the mediation apparatus ID of the mediation apparatus 300 from the HTTP header for registration in the file memory unit 111.

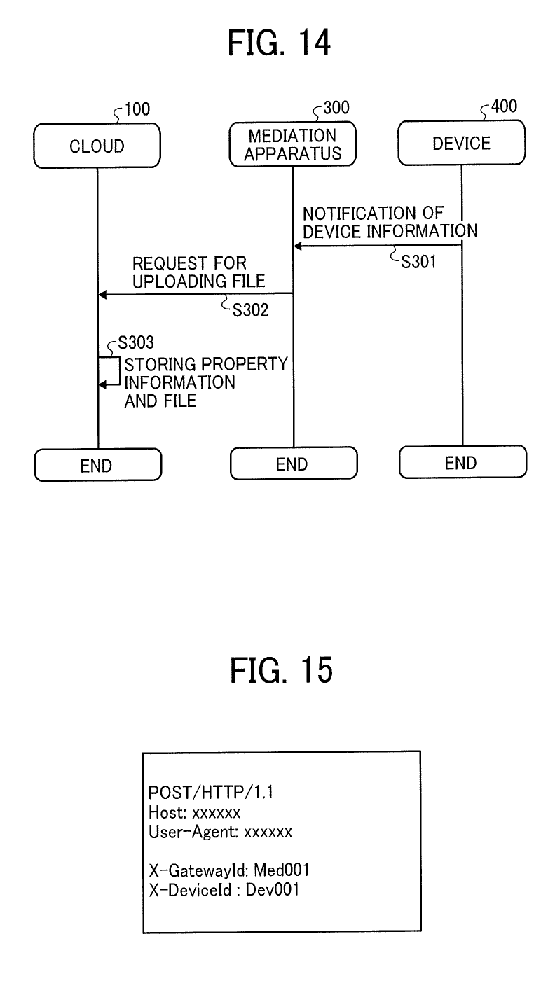

FIG. 14 is a sequence diagram illustrating an example of the flow of an upload process performed by the device 400 according to the embodiment via the mediation apparatus 300. For example, an upload process performed by the device 400 via the mediation apparatus 300 is performed when file data including device information is stored in the cloud 100.

As illustrated in FIG. 14, the device 400 notifies the mediation apparatus 300 of device information of the device 400 itself (Step S301). Furthermore, the mediation apparatus 300 transmits to the cloud 100 an upload request for uploading file data including the device information (Step S302). Here, the mediation apparatus 300 transmits an upload request including the device ID of the device 400, which has notified of the device information, and the mediation apparatus ID of the mediation apparatus 300 itself. That is to say, the upload request for uploading the file data includes the file data, the file ID of the file data, the mediation apparatus ID of the mediation apparatus 300, and the device ID of the device 400.

When the upload request from the mediation apparatus 300 is accepted, the cloud 100 registers the file data, the file ID, the device ID, which is upload-requesting-source information, etc., in the file memory unit 111 (Step S303). Furthermore, when the upload request does not include expiration date information and expiration date information is supposed to be set, the cloud 100 registers, as expiration date information, a date after a predetermined number of days.

At a time of an upload request for uploading file data, the mediation apparatus 300 adds to an HTTP header, etc., the mediation apparatus ID of the mediation apparatus 300 itself and the device ID of the device 400, which has notified of the device information. FIG. 15 is a diagram illustrating an example of an HTTP header transmitted at a time of an upload from the device 400 according to the embodiment. As illustrated in FIG. 15, the mediation apparatus 300 adds to the HTTP header the mediation apparatus ID of the mediation apparatus 300 itself and the device ID of the device 400 and provides an upload request for uploading the file data. Hence, it is possible that the cloud 100 obtains the device ID of the device 400 from the HTTP header for registration in the file memory unit 111.

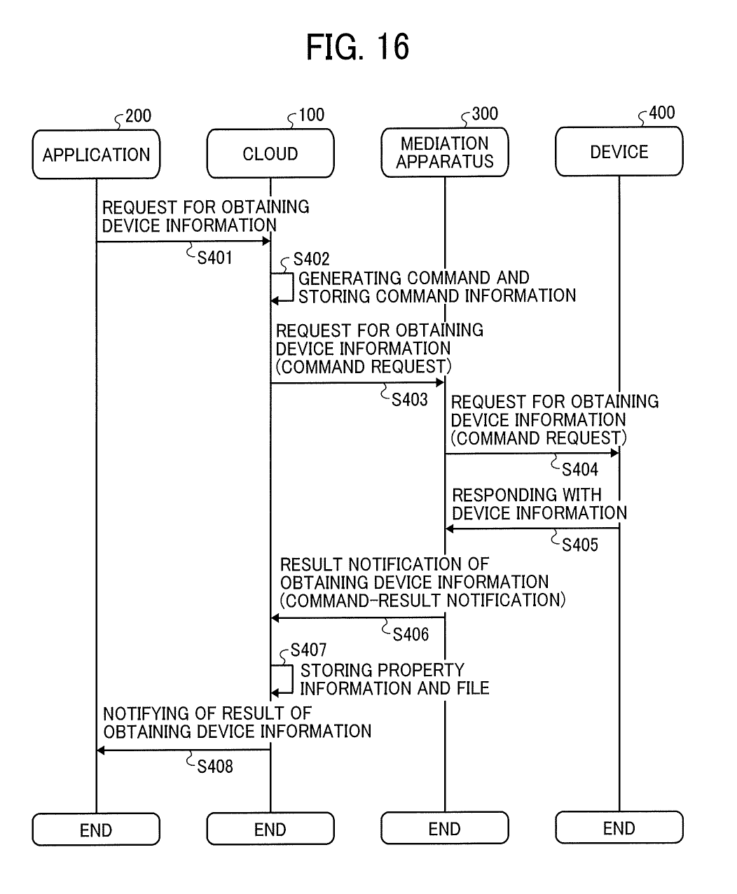

FIG. 16 is a sequence diagram illustrating an example of the flow of an upload process performed by the mediation apparatus 300 in response to a request from the application 200 according to the embodiment. For example, an upload process performed by the mediation apparatus 300 in response to a request from the application 200 is triggered and achieved when a request for allowing the application 200 to obtain device information of the device 400 is provided.

As illustrated in FIG. 16, the application 200 transmits to the cloud 100 a request for obtaining device information, which triggers generation of a command (Step S401). When the request from the application 200 for obtaining device information is accepted, the cloud 100 generates a command corresponding to the request and stores command information (Step S402). For example, the command information may be request information, etc., that is indicative of such information as a command ID, an application ID, a mediation apparatus ID, a device ID, and a requested content.

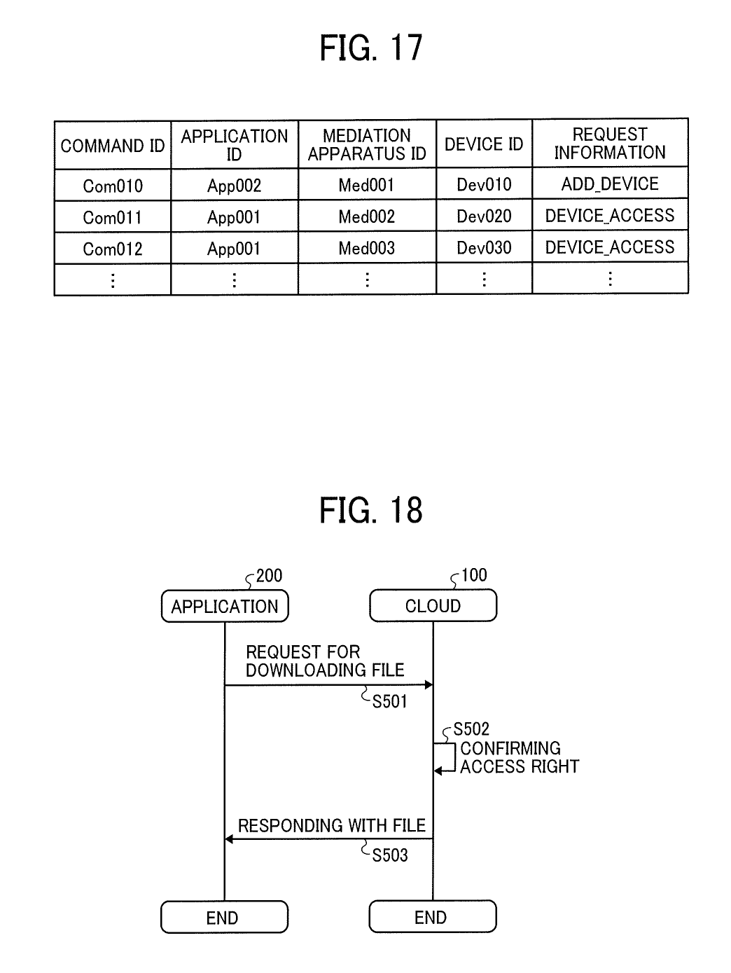

FIG. 17 is a diagram illustrating an example of command information according to the embodiment. As illustrated in FIG. 17, the cloud 100 stores, in an associated manner, such information as a command ID, an application ID, a mediation apparatus ID, a device ID, and request information, which are included in the request for obtaining device information. Regarding a request from the application 200 for obtaining device information, a request from the application 200 triggers the mediation apparatus 300 to obtain device information of the device 400 and to upload file data including the device information to the cloud 100. Hence, a request for obtaining device information includes a command ID, an application ID, a mediation apparatus ID, a device ID, and request information.

Then, the cloud 100 transmits a generated command to the mediation apparatus 300 and requests for executing a process corresponding to the command (Step S403). Upon receiving a command request, the mediation apparatus 300 requests the device 400 to obtain device information (Step S404). In response, the device 400 responds with file data including the device information (Step S405). Upon obtaining the device information from the device 400, the mediation apparatus 300 transmits to the cloud 100 the obtained file data including the device information as a command-result notification (Step S406). A command-result notification corresponds to an upload request for uploading file data including device information. Particularly, the mediation apparatus 300 transmits to the cloud 100 a command-result notification including the mediation apparatus ID of the mediation apparatus 300 itself, a command ID, a device ID, file data, and a command result (e.g., result: OK, etc.).

Upon receiving the command-result notification, the cloud 100 registers the file data, the file ID, the command ID, which is upload-requesting-source information, in the file memory unit 111 (Step S407). Furthermore, the cloud 100 registers expiration date information as well. Then, the cloud 100 notifies the application 200 of a result of obtaining the device information (Step S408).

<Download Process>

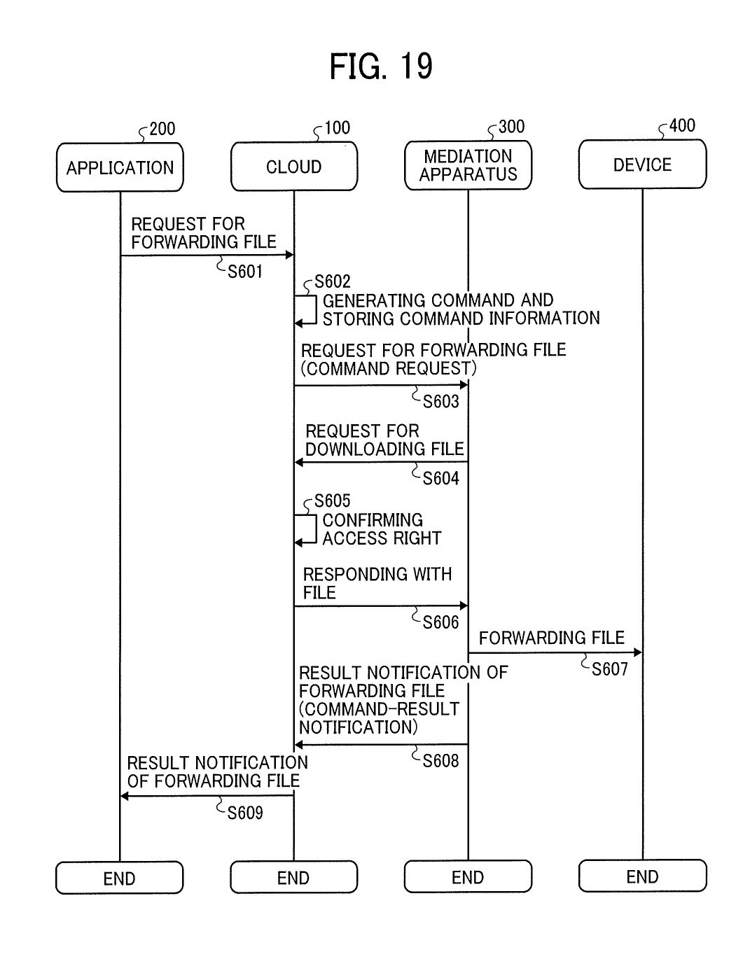

Next, with reference to FIGS. 18 and 19, a download process according to the embodiment is explained.

FIG. 18 is a sequence diagram illustrating an example of the flow of a download process in a case where the application 200 according to the embodiment is a download-requesting device. As illustrated in FIG. 18, the application 200 transmits to the cloud 100 a download request for downloading file data including the file ID of the file data, which is an obtaining target (Step S501). Upon receiving the download request, the cloud 100 confirms access authority over the file data and determines download availability of the file data (Step S502). Then, in a case where downloading in possible, the cloud 100 responds to the application 200 with the file data (Step S503).

FIG. 19 is a sequence diagram illustrating an example of the flow of a download process in a case where the mediation apparatus 300 according to the embodiment is a download-requesting device. In FIG. 19, a case in which a file-forwarding request from the application 200 triggers the mediation apparatus 300 to provide the cloud 100 with a download request for downloading file data to be forwarded to the device 400 is taken as an example.

As illustrated in FIG. 19, the application 200 transmits to the cloud 100 a request for forwarding file data including the device ID of the target device 400 and the file ID of the file data (Step S601). Upon receiving the file-forwarding request, the cloud 100 generates a command corresponding to the request and stores command information (Step S602). Furthermore, the cloud 100 transmits the generated command to the mediation apparatus 300 and requests for executing a process corresponding to the command (Step S603). Upon receiving the command request, the mediation apparatus 300 transmits to the cloud 100 a download request for downloading the file data (Step S604).

When the download request for downloading the file data is accepted, the cloud 100 confirms access authority over the file data and determines download availability of the file data (Step S605). Then, in a case where downloading is possible, the cloud 100 responds to the mediation apparatus 300 with the file data (Step S606). The mediation apparatus 300 forwards to the device 400 the file data, which is provided by the cloud 100 as a response (Step S607). Then, the mediation apparatus 300 transmits to the cloud 100 a result notification of forwarding file, which is indicative of completion of forwarding the file (Step S608). The cloud 100 transmits to the application 200 the result notification of forwarding the file (Step S609).

<Determining Process at a Time of an Upload>

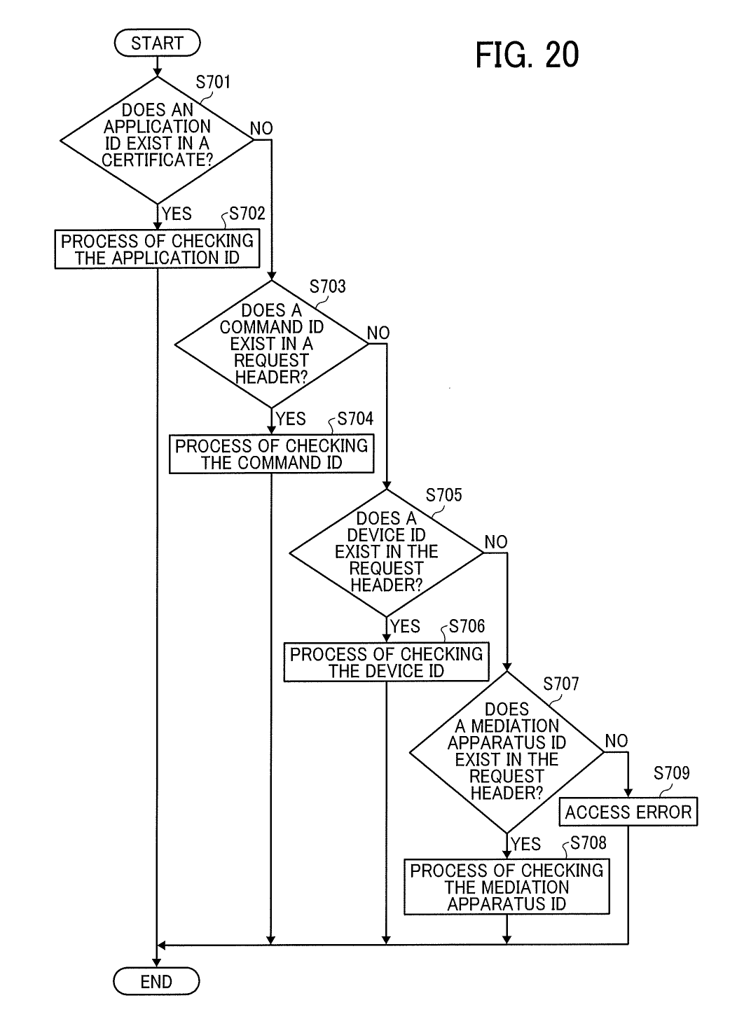

Next, with reference to FIG. 20, a determining process at a time of an upload according to the embodiment is explained. FIG. 20 is a flowchart illustrating an example of the flow of a determining process at a time of an upload according to the embodiment. The determining process at a time of an upload is a process executed by the cloud 100 when an upload request for uploading file data is accepted.

As illustrated in FIG. 20, upon accepting an upload request for uploading file data, the cloud 100 determines whether an application ID exists in a certificate (Step S701). Here, in a case where an application ID exists in the certificate (Step S701: Yes), the cloud 100 executes a process of checking whether the application ID is an ID that really exists (Step S702). The process of checking an ID may be performed by confirming whether the ID itself exits, based on information of each ID, which is held by the cloud 100 in advance.

Contrarily, in a case where an application ID does not exist in the certificate (Step S701: No), the cloud 100 determines whether a command ID exists in a request header (e.g., an HTTP header) (Step S703). Here, in a case where a command ID exists (Step S703: Yes), the cloud 100 executes a process of checking whether the command ID is an ID that really exists (Step S704).

Contrarily, in a case where a command ID does not exist in a request header (Step S703: No), the cloud 100 determines whether a device ID exists in the request header (Step S705). Here, in a case where a device ID exists (Step S705: Yes), the cloud 100 executes a process of checking whether the device ID is an ID that really exists (Step S706).

Contrarily, in a case where a device ID does not exist in the request header (Step S705: No), the cloud 100 determines whether a mediation apparatus ID exists in the request header (Step S707). Here, in a case where a mediation apparatus ID exists in the request header (Step S707: Yes), the cloud 100 executes a process of checking whether the mediation apparatus ID is an ID that really exists (Step S708). Contrarily, in a case where a mediation apparatus ID does not exist in the request header (Step S707: No), the cloud 100 responds to the upload-requesting device with an access error (Step S709).

<Determining Process at a Time of a Download>

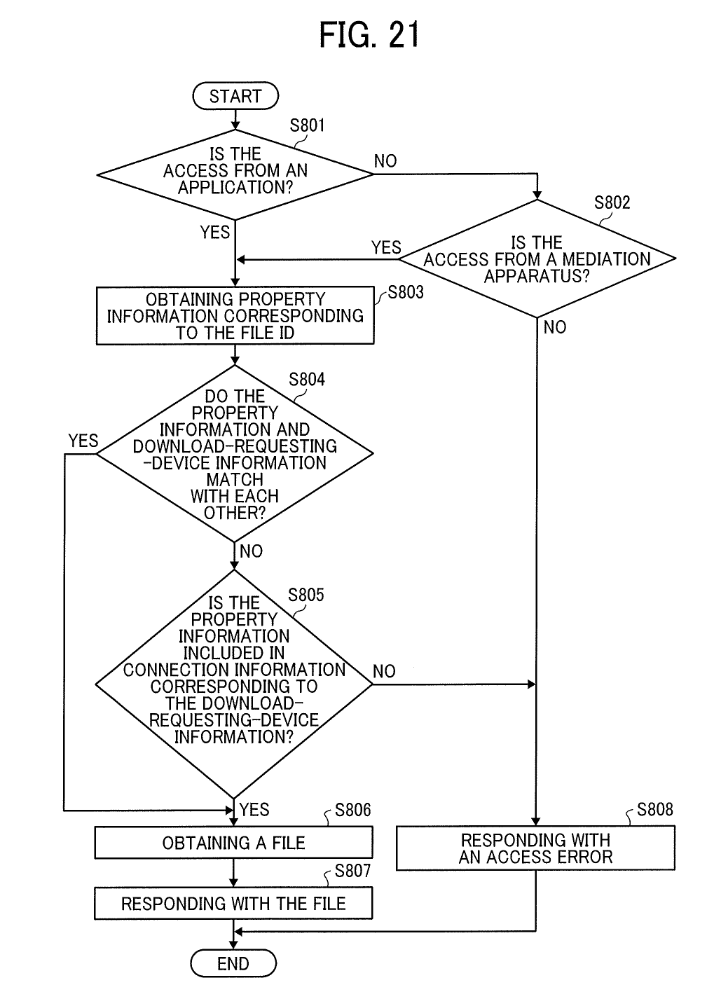

Next, with reference to FIG. 21, a determining process at a time of a download according to the embodiment is explained. FIG. 21 is a flowchart illustrating an example of the flow of a determining process at a time of a download according to the embodiment. The determining process at a time of a download is a process performed by the cloud 100, at a time of receiving a download request for downloading file data, to confirm access authority over the file data.

As illustrated in FIG. 21, the cloud 100 determines whether an access is from the application 200 (Step S801). Here, in a case where the access is not from the application 200 (Step S801: No), the cloud 100 determines whether the access is from the mediation apparatus 300 (Step S802).

In a case where the access is from the application 200 (Step S801: Yes) or in a case where the access is from the mediation apparatus 300 (Step S802: Yes), the cloud 100 obtains from the file memory unit 111 property information corresponding to the file ID (Step S803). Here, the cloud 100 determines whether the obtained property information matches with download-requesting-device information (Step S804). Here, in a case where the property information matches with the download-requesting-device information (Step S804: Yes), the cloud 100 obtains corresponding file data (Step S806).

Furthermore, in a case where the property information does not match with the download-requesting-device information (Step S804: No), the cloud 100 determines whether connection information corresponding to the download-requesting-device information includes property information (Step S805). Here, in a case where the connection information corresponding to the download-requesting-device information includes property information (Step S805: Yes), the cloud 100 obtains corresponding file data (Step S806). Contrarily, in a case where the access is not from the mediation apparatus 300 (Step S802: No) or in a case where the connection information corresponding to the download-requesting-device information does not include property information (Step S805: No), the cloud 100 responds with an access error (Step S808). Upon obtaining the file data, the cloud 100 responds to the download-requesting device with the obtained file data (Step S807).

As described above, at a time of uploading file data, the cloud 100 registers upload-requesting-source information, which is used for determining download availability of the file data. Therefore, it is possible to enhance security regarding obtainment of the file data.

Furthermore, in a case where information of a device that has requested for downloading file data matches with upload-requesting-source information, the cloud 100 provides corresponding file data as a response. This can enhance security regarding obtainment of the file data.

Furthermore, in a case where information of a device that has requested for downloading file data does not match with upload-requesting-source information, the cloud 100 determines whether upload-requesting-source information exists in connection information including information of the device that has requested for the download and, in a case where the upload-requesting-source information exists in the connection information, the cloud 100 provides corresponding file data as a response. This can enhance security regarding obtainment of the file data.

Conventionally, file data can be downloaded, using a file ID, a predetermined passcode, etc., and therefore downloading is possible even for a device that does not actually have access authority over the file data. As a result, security in obtaining file data has been weak.

Contrarily, according to at least one embodiment as described above, upload-requesting-source information is registered. This improves security in obtaining file data.

Furthermore, it is possible to change a processing procedure, a control procedure, a specific name, or information including various types of data, parameters, etc., which are described in the above specification or in the drawings, etc., as appropriate, unless otherwise noted. Furthermore, each constituent element of illustrated devices is conceptual in a functional aspect and therefore it is not necessary that the configuration is as illustrated in a physical aspect. In other words, the specific way of dividing or combining with respect of a device is not limited to as illustrated and therefore it is possible to divide or combine all or a part of the constituent elements in a functional or physical aspect on a predetermined unit basis in consideration of various types of loads, usage conditions, etc.

Furthermore, as a model of practice, the information processing program executed in the cloud 100 may be provided in a way of being stored in a computer-readable recording medium, such as a CD-ROM, a flexible disk (FD), a CD-R, or a digital versatile disk (DVD), as a file in an installable format or in an executable format. Furthermore, regarding a configuration, the information process program executed in the cloud 100 may be stored in a computer coupled with a network such as the Internet, so as to be provided in a way of being downloaded via a network. Furthermore, regarding a configuration, the information process program executed in the cloud 100 may be provided or distributed via a network such as the Internet. Furthermore, regarding a configuration, the information process program may be provided in a way of being embedded in a ROM, etc., in advance.

An information processing program executed in the cloud 100 has a module configuration including the above-described units (i.e., the obtaining unit 121 and registering unit 122) at least. Further, the actual hardware is a CPU (i.e., a processer) that executes the information processing program retrieved from a recording medium, so as to load the above-described units on the primary memory such that the obtaining unit 121 and the registering unit 122 are generated in the primary memory.

Any one of the above-described operations may be performed in various other ways, for example, in an order different from the one described above.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

1. An information processing apparatus comprising processing circuitry configured to:
obtain upload-requesting-source information indicating at least one requesting source that has requested for uploading file data; and
register, in a memory, the obtained upload-requesting-source information, the upload-requesting-source information to be used to determine download availability of the file data.

2. The information processing apparatus according to claim 1, wherein the processing circuitry is further configured to:
determine whether the upload-requesting-source information matches download-requesting-device information, the download-requesting-device information indicating a device that has requested for downloading the file data; and
transmit the file data to the device, based on a determination that the upload-requesting-source information matches the download-requesting-device information.

3. The information processing apparatus according to claim 2, further comprising:
the memory configured to store connection information indicating a connection state of the at least one requesting source of the upload request for transmitting and receiving information, and
wherein the processing circuitry is configured to:
determine whether the upload-requesting-source information is included in the connection information associated with the download-requesting device information based on a determination that the upload-requesting-source information does not match the download-requesting-device information; and
transmit the file data to the device based on a determination that the upload-requesting-source information is included in the connection information associated with the download-requesting device information.

4. The information processing apparatus according to claim 2, wherein the processing circuitry is further configured to:
register expiration date information indicating an expiration date at which downloading of the file data is expired; and
transmit the file data to the device based on a determination that downloading of the file data is available according to the expiration date information.

5. The information processing apparatus according to claim 2,
wherein the processing circuitry encrypts the file data before registration of the file data in the memory, and
wherein the processing circuitry decrypts the file data before transmission of the file data to the device.

6. An information processing system comprising:
a requesting device; and
an information processing apparatus,
wherein the requesting device includes first circuitry configured to
transmit to the information processing apparatus an upload request including identification information of all devices that have been involved to request for uploading file data, and
wherein the information processing apparatus includes second circuitry configured to:
receive the upload request from the requesting device;
obtain, based on the identification information included in the received upload request, upload-requesting-source information indicating at least one requesting source of the upload request of file data; and
register, in a memory, the obtained upload-requesting-source information, the upload-requesting-source information to be used to determine download availability of the file data.

7. The information processing system according to claim 6, the second circuitry being configured to:
determine whether the upload-requesting-source information matches download-requesting-device information, the download-requesting-device information indicating a device that has requested for downloading the file data; and
transmit the file data to the device, based on a determination that the upload-requesting-source information matches the download-requesting-device information.

8. The information processing system according to claim 7,
wherein the memory is configured to store connection information indicating a connection state of the at least one requesting source of the upload request for transmitting and receiving information, and
wherein the second circuitry is configured to:
determine whether the upload-requesting-source information is included in the connection information associated with the download-requesting device information based on a determination that the upload-requesting-source information does not match the download-requesting-device information; and
transmit the file data to the device based on a determination that the upload-requesting-source information is included in the connection information associated with the download-requesting device information.

9. The information processing system according to claim 7, the second circuitry being configured to:
register expiration date information indicating an expiration date at which downloading of the file data is expired; and
transmit the file data to the device based on a determination that downloading of the file data is available according to the expiration date information.

10. The information processing system according to claim 7,
wherein the second circuitry encrypts the file data before registration of the file data in the memory, and
wherein the second circuitry decrypts the file data before transmission of the file data to the device.

11. An information processing method performed by an information processing apparatus, the information processing method comprising:
obtaining upload-requesting-source information indicating at least one requesting source that has requested for uploading file data; and
registering, in a memory, the obtained upload-requesting-source information, the upload-requesting-source information to be used to determine download availability of the file data.

12. The information processing method according to claim 11, the information processing method comprising:
determining whether the upload-requesting-source information matches download-requesting-device information, the download-requesting-device information indicating a device that has requested for downloading the file data, the upload-requesting-source information being stored in the memory; and
transmitting the file data to the device, based on a determination that the upload-requesting-source information matches the download-requesting-device information.

13. The information processing method according to claim 12, further comprising:
storing, in the memory, connection information indicating a connection state of the at least one requesting source of the upload request for transmitting and receiving information;
determining whether the upload-requesting-source information is included in the connection information associated with the download-requesting device information based on a determination that the upload-requesting-source information does not match the download-requesting-device information; and
transmitting the file data to the device based on a determination that the upload-requesting-source information is included in the connection information associated with the download-requesting device information.

14. The information processing method according to claim 12, the information processing method further comprising:
registering expiration date information indicating an expiration date at which downloading of the file data is expired; and
transmitting the file data to the device based on a determination that downloading of the file data is available according to the expiration date information.

15. The information processing method according to claim 12, further comprising:
encrypting the file data before registration of the file data in the memory; and
decrypting the file data before transmission of the file data to the device.
